(19) United States
(12) Patent Application Publication
(10) Pub. No.: US 2014/0302896 A1
(43) Pub. Date: Oct. 9, 2014

(54) Portable Charging System for a Smartphone

(71) Applicants: Ye Xu, Sugar Land, TX (US); Benjamin Aaron Adler, Houston, TX (US)

(72) Inventors: Ye Xu, Sugar Land, TX (US); Benjamin Aaron Adler, Houston, TX (US)

(21) Appl. No.: 14/244,678

(22) Filed: Apr. 3, 2014

Related U.S. Application Data
(60) Provisional application No. 61/808,491, filed on Apr. 4, 2013.

(51) Int. Cl. H04B 1/38; H04M 1/02

(52) U.S. Cl. CPC H04B 1/3883; H04M 1/0202; H04B 1/3888
USPC 455/574

(57) ABSTRACT

Provided herein is an electronically-linkable protective smartphone case and a portable charging system comprising the protective case and a charging holster. The protective case has means for contacting a battery disposed in the charging holster and means for electronically contacting the charging port of a smartphone disposed within the protective case. The portable charging system comprises the charging holster into which the protective case/smartphone are slidably received and in contact with the battery terminals of the charging holster battery. Also provided is a method for charging a smartphone by electronically connecting the smartphone within the protective case and contacting the protective case to the battery in the charging holster whereby a charge is delivered to the smartphone battery.

### CROSS-REFERENCE TO RELATED APPLICATION

This nonprovisional application claims benefit of priority under 35 U.S.C. §119(e) of provisional application U.S. Ser. No. 61/808,491, filed Apr. 4, 2013, now abandoned, the entirety of which is hereby incorporated by reference.

### BACKGROUND OF THE INVENTION

The present invention relates generally to the fields of smartphones and phone chargers. More specifically, the present invention relates to a portable system for charging a smartphone that can be worn or easily carried by a user without subsequent damage to the battery charger.

### Description of the Related Art

As with most of today's portable electronics, a smartphone requires periodic charging of its battery. Charging cases and charging holsters enable a smartphone to be charged anywhere and at any time with the added convenience of easy unencumbered transportation. However, with continued use of a charging holster, there is a likelihood of damaging the connector to the smartphone rendering the charging holster useless as a battery charger.

Thus, there is a recognized need in the art for an improved means for portably charging a smartphone. Particularly, the prior art is deficient in a system that includes a protective case that protectively, electronically links a charging holster battery with the smartphone charging port. The present invention fulfills this longstanding need and desire in the art.

### SUMMARY OF THE INVENTION

The present invention is directed to a device for electronically linking a smartphone to a charger. The device comprises a portable protective case with an open substantially rectangular body with interior dimensions configured to securely encase a perimeter of the smartphone. The protective case has means for electronically connecting to the smartphone and means for contacting battery terminals on the charger.

The present invention also is directed to a smartphone charging system. The system comprises a protective case and a charging holster. The protective case is formed as a substantially rectangular body with an open front that is coincident with a smartphone screen when the smartphone is disposed therewithin. The protective case has battery terminal contacts disposed on an exterior bottom surface thereof and has a connector disposed on an interior bottom surface thereof in connectable alignment with a charging port on the smartphone. The charging holster is formed as a cup-like body with open front and top surfaces such that the open front surface is coincident with the open front of the protective case when the protective case is slidably received within the cup-like body. The charging holster has a battery disposed within a bottom portion of said cup-like body such that battery terminals are in contactable alignment with the battery terminal contacts on the protective case.

The present invention is directed to a related smartphone charging system in which the charging holster further comprises a clip or loop disposed on or formed from a back exterior surface of the holster and is attachable to an article of clothing or to a strap. The present invention is directed to another related smartphone charging system in which the charging holster further comprises a charging port disposed on an exterior surface thereof configured to receive a connector connected to a charger for the battery. The present invention is directed to yet another related smartphone charging system in which the charging holster further comprises an on/off switch disposed on an exterior surface thereof and operationally linked to the battery.

The present invention is directed further to a method for charging a smartphone. The method comprises inserting a smartphone into a protective case that has an open front sized to receive the smartphone therein and connecting electronically a charging port on the smartphone to a connector disposed within the protective case. sliding The protective case with smartphone is slid into a charging holster that has open top and front surfaces sized to receive the protective case/smartphone therein and contacting battery terminals comprising a battery disposed within the charging holster to battery terminal contacts disposed on an exterior surface of the protective case. A charge is delivered to a battery comprising the smartphone via the protective case contact with the charging holster battery and the electronic connection to the smartphone charging port which charges the smartphone.

Other and further aspects, features, and advantages of the present invention will be apparent from the following description of the presently preferred embodiments of the invention given for the purpose of disclosure.

### BRIEF DESCRIPTION OF THE DRAWINGS

So that the matter in which the above-recited features, advantages and objects of the invention, as well as others that will become clear, are attained and can be understood in detail, more particular descriptions of the invention briefly summarized above may be had by reference to certain embodiments thereof that are illustrated in the appended drawings. These drawings form a part of the specification. It is to be noted, however, that the appended drawings illustrate preferred embodiments of the invention and therefore are not to be considered limiting in their scope.

FIGS. 1A-1B depict the protective case (FIG. 1A) and charging holster (FIG. 1B) components of the portable charging system.

FIG. 2 demonstrates how the portable charging system is assembled.

### DETAILED DESCRIPTION OF THE INVENTION

In one embodiment of the invention there is provided a device for electronically linking a smartphone to a charger, comprising a portable protective case with an open substantially rectangular body with interior dimensions configured to securely encase a perimeter of the smartphone, where the protective case has means for electronically connecting to the smartphone and means for contacting battery terminals on the charger.

In one aspect of this embodiment, the protective case may comprise an exterior body portion with an open front and an exterior bottom surface having battery terminal contacts disposed thereon; and an open interior body portion formed within the exterior body portion with an interior bottom surface having a connector disposed electronically connectable to a charging port on the smartphone.

In this embodiment and aspect thereof, the charger may be a charging holster comprising a cup-like body with open front and top surfaces and a bottom portion that are configured to securely, slidably receive the protective case therein, said cup-like body having a battery disposed in said bottom portion and in contact with the protective case. Further to these aspects, the charging holster may comprise means for attaching the holster to an article of clothing or to a strap disposed on or formed from a back exterior surface of the cup-like body. Further still, the charging holster may comprise a charging port disposed on an exterior surface of the cup-like body configured to receive a connector connected to a charger for the battery. Yet further still, the charging holster may comprise an on/off switch disposed on an exterior surface of the cup-like body and operationally linked to the battery.

In a particular aspect, the cup-like body may comprise an exterior body portion cupped to form the open front and top surfaces such that a smartphone screen is coincident with the open front surface when the protective case comprising the smartphone is received within the cup-like body; and an open interior body portion formed within the exterior body portion and having an interior bottom surface with terminals comprising the battery disposed thereon in alignment with battery terminal contacts disposed on the protective case.

In embodiments and aspects thereof the protective case may comprise a cushioning material. Also, the protective case may be portable. In addition, the charging holster may be portable.

In another embodiment of the present invention, there is provided a smartphone charging system, comprising a protective case formed as a substantially rectangular body with an open front that is coincident with a smartphone screen when the smartphone is disposed therewithin, where the protective case has battery terminal contacts disposed on an exterior bottom surface thereof and has a connector disposed on an interior bottom surface thereof in connectable alignment with a charging port on the smartphone; and a charging holster formed as a cup-like body with open front and top surfaces such that the open front surface is coincident with the open front of the protective case when the protective case is slidably received within the cup-like body, where the charging holster has a battery disposed within a bottom portion of the cup-like body such that battery terminals are in contactable alignment with the battery terminal contacts on the protective case.

Further to this embodiment the charging holster may comprise a clip or loop disposed on or formed from a back exterior surface of the holster and is attachable to an article of clothing or to a strap. In another further embodiment, the charging may comprise a charging port disposed on an exterior surface thereof configured to receive a connector connected to a charger for the battery. In yet another further embodiment, the charging may comprise an on/off switch disposed on an exterior surface thereof and operationally linked to the battery.

In all embodiments the protective case may comprise a cushioning material. Also, the protective case and the charging holster may be independently portable.

In yet another embodiment of the present invention, there is provided a method for for charging a smartphone, comprising inserting a smartphone into a protective case having an open front sized to receive the smartphone therein; connecting electronically a charging port on the smartphone to a connector disposed within the protective case; sliding the protective case with smartphone into a charging holster having open top and front surfaces sized to receive the protective case/smartphone therein; contacting battery terminals comprising a battery disposed within the charging holster to battery terminal contacts disposed on an exterior surface of the protective case; and delivering a charge to a battery comprising the smartphone via the protective case contact with the charging holster battery and the electronic connection to the smartphone charging port, thereby charging the smartphone.

Further to this embodiment the method may comprise connecting a charging port disposed on the charging holster to an electronic connector on a charger to charge the charging holster battery. In another further embodiment, the charging holster may comprises a switch to turn on and off the battery disposed therein, where the step of delivering a charge to the smartphone battery is controlled by a user of the smartphone. In yet another further embodiment, the charging holster may comprise a clip or loop disposed on or formed from a back surface of the charging holster such that the charging holster with protective case and smartphone received therein comprises a portable charging system, where the method comprises removably clipping or looping the portable charging system to an article of clothing worn by a user of the smartphone or to a strap of a carrier carried by the user.

Provided herein are a device and portable system for charging smartphones. The device comprises a means for securing and protecting a smartphone and a means for electronically linking or connecting the smartphone to a charger. The portable system comprises the device and a portable charger that is a holster with a means for charging a smartphone and means for charging itself that are built into the holster body. The portable charging system comprises a means for attaching or clipping the system to a belt, for example, so that the phone is transportable and easily retrieved from the holster without damaging the charging means.

The portable charging system is configured for any smartphone. Representative examples are, but not limited to, Apple® iOS®-based phones, such as iPhone®, which are trademarks of Apple Inc., registered in the U.S. and other countries, and Android®-based smartphones, which is a registered trademark of Google Inc. As such, the means for linking the smartphone to a battery charger via the protective case and the charging holster itself to another charging device generally are compatible with the charging ports in the smartphone and the charging holster, such as, a connector on a micro USB cable, as is known and standard in the art.

As used herein in the specification, “a” or “an” may mean one or more. As used herein in the claim(s), when used in conjunction with the word “comprising”, the words “a” or “an” may mean one or more than one.

As used herein “another” or “other” may mean at least a second or more of the same or different claim element or components thereof. Similarly, the word “or” is intended to include “and” unless the context clearly indicates otherwise.

“Comprise” means “include.”

As described below, the invention provides a number of advantages and uses, however such advantages and uses are not limited by such description. Embodiments of the present invention are better illustrated with reference to the Figure(s), however, such reference is not meant to limit the present invention in any fashion. The embodiments and variations described in detail herein are to be interpreted by the appended claims and equivalents thereof.

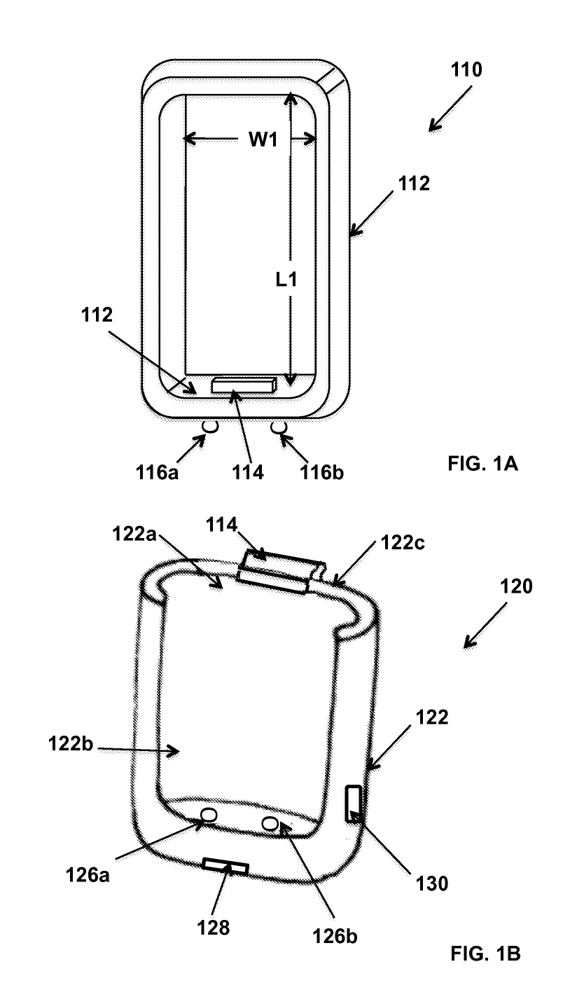

FIG. 1A depicts the protective case 110 and the charging holster 120. The protective case has an open rectangular body 112 comprising an exterior body portion with an open interior body portion formed thereby and having dimensions of length L1 and width W1 sufficient to protectively and securely encase the smartphone around its perimeter. The bottom surface 112a of the protective case comprises means 114 to electronically connect to the charging port on a smartphone when it is positioned within the protective case that is disposed on the interior of the bottom surface of the protective case to align with the charging port and means 116a,b for contacting the terminals of a battery disposed on the bottom surface of the exterior body portion of the protective case. For example, the smartphone connecting means 114 may be or similar to a connecter such as comprises a micro USB cable. The contacts 116a,b are electronically linked to the smartphone contacting means 114. The protective case comprises a cushioning material, such as, but not limited to, a cushioning foam or other polymer that can effectively secure and cushion a smartphone therein, but is sufficiently sturdy to support the smartphone connector and contacts and securely maintain the electronic connection or link therebetween.

FIG. 1B depicts the charging holster 120. The charging holster 120 has a body 122 that generally comprises a cup-like shape with open top 122a and front 122b surfaces with dimensions to receive a smartphone therein. The cup-like body comprises a cupped exterior body portion and an open interior body portion formed thereby. The open front surface is cut out only enough to securely receive and hold the smartphone and protective case combination therein such that the screen is coincident with the open front of the protective case and the open surface of the cup-like body of the charging holster and remains viewable. The back surface 122c of the exterior body portion of the charging holster has a clip 124, loop or other means of attaching the charging holster to, for example, an article of clothing such as a belt, pant waistband, pocket or to other strap such as comprises a backpack or purse such or other carrier affixed or attached thereto or formed therefrom. For example, the charging holster may be clipped over a belt or a belt may be threaded through a loop affixed to the back surface. The charging holster comprises a battery disposed within the bottom portion of the cup-like body and comprises terminals 126a,b disposed on the interior bottom surface of the open interior body portion that are configured to securely contact the contacts 116a,b on the protective case. For example, the contacts 116a,b may have a shape that securely mates with the battery terminals 126a,b, such as in a male/female configuration, respectively. The charging holster also comprises a charging port 128 configured to receive a connector on a micro USB cable so that the battery may be charged, as necessary. Optionally, the charging holster may comprise a means 130 for switching the battery on or off, such as a slide, button or flip switch disposed on the exterior of the holster that is operationally linked to the battery.

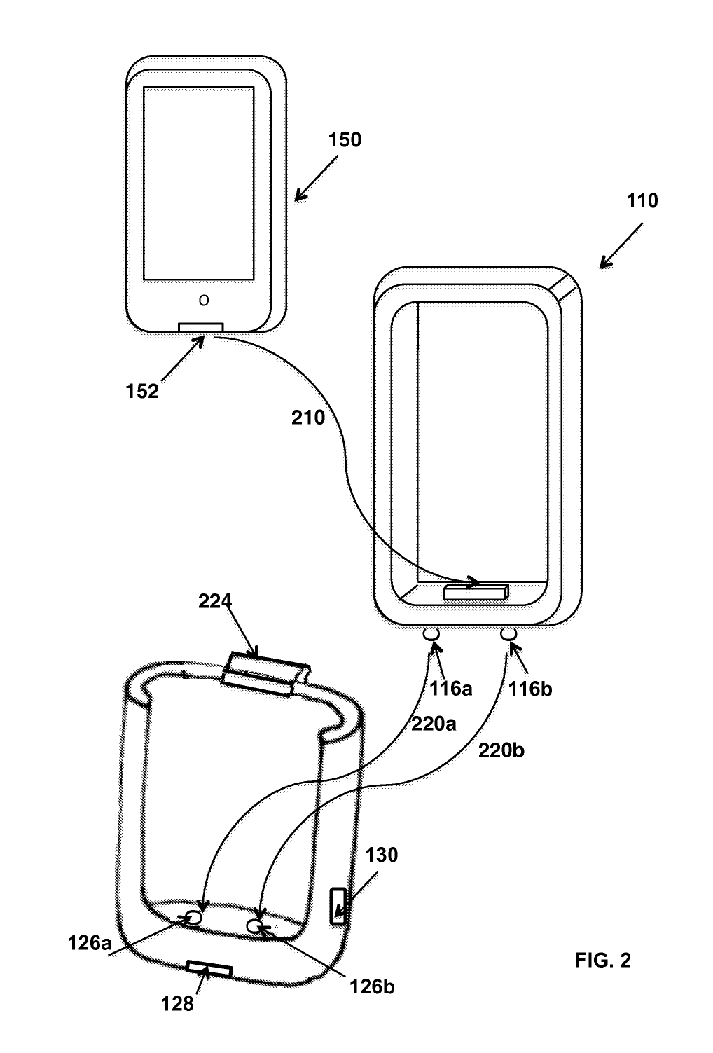

With continued reference to FIGS. 1A-1B, FIG. 2 illustrates how the portable charging system charges a smartphone. At step 210, a smartphone 150 is positioned within the protective case 110 such that the smartphone is encased by the protective case and the charging port 152 of the phone is connected to the connector 114 comprising the protective case. The protective case/smartphone combination is inserted into the charging holster 120 such that the contacts 116a,b comprising the protective case are aligned and in contact with the battery terminals 126a,b at step 220a,b. When contact is established the battery delivers a charge to the smartphone battery via the electronic links provided by the protective case.

Alternatively, if the charging holster comprises the switching means 130, charging may be regulated by the user of the smartphone. The portable charging system containing the smartphone may be worn on the belt or in a pocket of the user by slipping the clip 124 over the belt or the pocket or may be clipped or looped over a strap. The system may be connected to a separate charger via the holster charging port 128 to charge the charging holster battery or both the battery and the smartphone.

One skilled in the art will appreciate readily that the present invention is well adapted to carry out the objects and obtain the ends and advantages mentioned, as well as those objects, ends and advantages inherent herein. The present devices, systems and methods described herein are presently representative of preferred embodiments, are exemplary, and are not intended as limitations on the scope of the invention. Changes therein and other uses will occur to those skilled in the art which are encompassed within the spirit of the invention as defined by the scope of the claims.

What is claimed is:

1. A device for electronically linking a smartphone to a charger, comprising:
a protective case with an open substantially rectangular body with interior dimensions configured to securely encase a perimeter of the smartphone, said protective case having means for electronically connecting to the smartphone and means for contacting battery terminals on the charger.

2. The device of claim 1, wherein the protective case comprises:
an exterior body portion with an open front and an exterior bottom surface having battery terminal contacts disposed thereon; and
an open interior body portion formed within the exterior body portion with an interior bottom surface having a connector disposed thereon and electronically connectable to a charging port on the smartphone.

3. The device of claim 1, wherein the protective case comprises a cushioning material.

4. The device of claim 1, wherein the protective case is portable.

5. The device of claim 1, wherein the charger is a charging holster comprising:
a cup-like body with open front and top surfaces and a bottom portion that are configured to securely, slidably receive the protective case therein, said cup-like body having a battery disposed in said bottom portion and in contact with the protective case.

6. The device of claim 5, wherein the cup-like body comprises:
an exterior body portion cupped to form the open front and top surfaces such that a smartphone screen is coincident with the open front surface when the protective case comprising the smartphone is received within the cup-like body; and
an open interior body portion formed within the exterior body portion and having an interior bottom surface with terminals comprising the battery disposed thereon in alignment with battery terminal contacts disposed on the protective case.

7. The device of claim 5, wherein the charging holster further comprises means for attaching the holster to an article of clothing or to a strap disposed on or formed from a back exterior surface of the cup-like body.

8. The device of claim 5, wherein the charging holster further comprises a charging port disposed on an exterior surface of the cup-like body configured to receive a connector connected to a charger for the battery.

9. The device of claim 5, wherein the charging holster further comprises an on/off switch disposed on an exterior surface of the cup-like body and operationally linked to the battery.

10. The device of claim 1, wherein the charging holster is portable.

11. A smartphone charging system, comprising:
a protective case formed as a substantially rectangular body with an open front that is coincident with a smartphone screen when the smartphone is disposed therewithin, said protective case having battery terminal contacts disposed on an exterior bottom surface thereof and having a connector disposed on an interior bottom surface thereof in connectable alignment with a charging port on the smartphone; and
a charging holster formed as a cup-like body with open front and top surfaces such that the open front surface is coincident with the open front of the protective case when the protective case is slidably received within the cup-like body, said charging holster having a battery disposed within a bottom portion of said cup-like body such that battery terminals are in contactable alignment with the battery terminal contacts on the protective case.

12. The smartphone charging system of claim 11, wherein the charging holster further comprises a clip or loop disposed on or formed from a back exterior surface of the holster and attachable to an article of clothing or to a strap.

13. The smartphone charging system of claim 11, wherein the charging holster further comprises a charging port disposed on an exterior surface thereof configured to receive a connector connected to a charger for the battery.

14. The smartphone charging system of claim 11, wherein the charging holster further comprises an on/off switch disposed on an exterior surface thereof and operationally linked to the battery.

15. The smartphone charging system of claim 11, wherein the protective case comprises a cushioning material.

16. The smartphone charging system of claim 11, wherein the protective case and the charging holster are independently portable.

17. A method for charging a smartphone, comprising:
inserting a smartphone into a protective case having an open front sized to receive the smartphone therein;
connecting electronically a charging port on the smartphone to a connector disposed within the protective case;
sliding the protective case with smartphone into a charging holster having open top and front surfaces sized to receive the protective case/smartphone therein;
contacting battery terminals comprising a battery disposed within the charging holster to battery terminal contacts disposed on an exterior surface of the protective case; and
delivering a charge to a battery comprising the smartphone via the protective case contact with the charging holster battery and the electronic connection to the smartphone charging port, thereby charging the smartphone.

18. The method of claim 17, further comprising:
connecting a charging port disposed on the charging holster to an electronic connector on a charger to charge the charging holster battery.

19. The method of claim 17, wherein the charging holster comprises a switch to turn on and off the battery disposed therein, said step of delivering a charge to the smartphone battery controlled by a user of the smartphone.

20. The method of claim 17, wherein the charging holster comprises a clip or loop disposed on or formed from a back surface of the charging holster such that said charging holster with protective case and smartphone received therein comprises a portable charging system, said method further comprising removably clipping or looping the portable charging system to an article of clothing worn by a user of the smartphone or to a strap of a carrier carried by the user.
